(19) United States
(12) Patent Application Publication
(10) Pub. No.: US 2022/0127457 A1
(43) Pub. Date: Apr. 28, 2022

(54) POLYURETHANE-BASED COMPOSITION COMPRISING AT LEAST TWO ACRYLIC FUNCTIONS

(71) Applicant: BOSTIK SA, Colombes (FR)

(72) Inventors: Guillaume MICHAUD, Venette (FR); Marjorie PEREIRA-BAYART, Venette (FR)

(21) Appl. No.: 16/971,011

(22) PCT Filed: Feb. 22, 2019
(86) PCT No.: PCT/FR2019/050407

§ 371 Date: Aug. 19, 2020

(30) Foreign Application Priority Data
Feb. 23, 2018 (FR) 1851591

(51) Int. Cl. C08L 75/16; C09J 175/16

(52) U.S. Cl. CPC C08L 75/16; C09J 175/16

(57) ABSTRACT

The present invention concerns a composition comprising: a composition A comprising at least one polyurethane having at least two acrylic end functions T of the following formula (I): CH₂═CH—C(═O)—X— (I) where X represents —O— or —NRₐ— with Rₐ representing H for an alkyl radical comprising 1 to 22 carbon atoms, preferably 1 to 14 carbon atoms, X preferably representing —O—; and a composition B comprising: at least one polyamine B1 comprising only two —CH₂NH₂ groups; and at least one polyamine B2 comprising at least two primary amine functions —NH₂.

### FIELD OF THE INVENTION

The present invention relates to a polyurethane-based composition comprising at least two acrylic functions.

The invention also relates to a multilayer structure (or complex) which may be used notably in the field of flexible packaging, which comprises at least two layers of material bonded together by a layer of the composition according to the invention.

The present invention also relates to a complexing process suitable for the manufacture of said complex.

### TECHNOLOGICAL BACKGROUND

Flexible packagings intended for packaging very diverse products, such as those manufactured for the agrifood, cosmetics or detergents industries, generally consist of several thin layers (in the form of sheets or films), the thickness of which is between 5 and 150 μm and which consist of different materials, such as paper, a metal (for example aluminum) or thermoplastic polymers. The corresponding complex (or multilayer) film, the thickness of which can vary from 20 to 400 μm, makes it possible to combine the properties of the various individual layers of material and to thus provide the consumer with a combination of characteristics suitable for the final flexible packaging, for instance:
its visual appearance (notably that of the printed elements presenting the information relating to the packaged product and intended for the consumer),
a barrier effect to atmospheric moisture or oxygen,
contact with food without risk of toxicity or of modification to the organoleptic properties of the packaged foodstuffs,
chemical resistance for certain products, such as ketchup or liquid soap,
good resistance to high temperature, for example in the case of pasteurization or sterilization. In particular, the adhesive seal formed by crosslinking of the adhesive layer connecting the individual layers of the packaging has to retain a sufficient level of cohesion after heat treatment, in order to avoid any phenomenon of delamination.

To constitute the final packaging, the multilayer is generally formed by heat sealing, at a temperature ranging from about 120 to 250° C., this last technique also being used for closing the packaging around the product intended for the consumer.

The various layers of material of which the multilayer is composed are combined or assembled by laminating during industrial lamination processes.

These processes use adhesives (or glues) and devices (or machines) designed for this purpose. The multilayer film thus obtained is itself often termed a “laminate”.

These processes first of all comprise a step of coating the adhesive onto a first layer of material, which consists of a deposit of a continuous layer of adhesive with a controlled thickness generally less than 10 μm, corresponding to an amount of adhesive (or basis weight) which is also controlled, generally not exceeding 10 g/m². This coating step is followed by a step of laminating a second layer of material, which may be identical to or different from the first layer, consisting of the application under pressure of this second layer of material onto the first layer of material covered with the layer of adhesive.

Polyurethane-based adhesives bearing NCO end groups are commonly used for this type of application.

However, polyurethane-based compositions bearing NCO end groups generally have the drawback of including large residual contents of aromatic diisocyanate originating from the polyurethane synthesis reaction, which may lead to a certain number of drawbacks, notably toxicity problems. Specifically, the non-labeling of polyurethanes requires residual diisocyanate contents of less than 0.1% by weight. In order to obtain such low residual contents, the production processes may be restrictive. In addition, it has been observed that polyurethane compositions having a content of MDI monomer (aromatic diisocyanate) of less than or equal to 1% by weight relative to the weight of the polyurethane composition are highly viscous at room temperature and have stability problems over time in terms of viscosity.

Other types of polymer-based adhesive compositions comprising end groups of Michael acceptor type exist. However, these compositions do not make it possible to obtain multilayer structures that are resistant to a high-temperature heat treatment, such as pasteurization or sterilization. This may have the consequence of degrading the adhesive seal (presence of blisters, bubbles and/or channels in the adhesive seal), in particular rendering the multilayer structure unsuitable for the manufacture of flexible wrappings intended for packaging food products.

The aim of the present invention is to provide a polyurethane-based composition which does not have the drawbacks of the existing compositions, and in particular a composition which leads to a multilayer structure having better resistance to heat treatment, preferably better heat resistance with respect to the sterilization and/or pasteurization test.

### DESCRIPTION OF THE INVENTION

In the present patent application, unless otherwise indicated:
the amounts expressed in percentage form correspond to weight/weight percentages;
the hydroxyl number of an alcoholic compound represents the number of hydroxyl functions per gram of product, and is expressed in the form of the equivalent number of milligrams of potassium hydroxide (KOH) used in the assay of the hydroxyl functions, per gram of product;
the primary alkalinity represents the number of —NH₂ functions per gram of product, and is expressed in the form of the number of milliequivalents of —NH₂ per gram of product. It may be measured by NMR or by potentiometry according to methods that are well known to those skilled in the art;
the secondary alkalinity represents the number of —NH— functions per gram of product, and is expressed in the form of the number of milliequivalents of —NH— per gram of product. It may be measured by NMR or by potentiometry according to methods that are well known to those skilled in the art;
the total alkalinity represents the number of amino functions (of primary, secondary and tertiary amine type) per gram of product, and is expressed in the form of milliequivalents of HCl per gram of product. The total alkalinity may be determined by NMR or by potentiometric assay;
the measurement of viscosity at 23° C. may be performed using a Brookfield viscometer according to the standard ISO 2555. Typically, the measurement taken at 23° C. may be performed using a Brookfield RVT viscometer with a spindle suitable for the viscosity range and at a rotational speed of 20 revolutions per minute (rpm). The viscosity of a product is preferably measured at least 24 hours after manufacturing said product;
the number-average molecular masses (Mn) of the polyols, expressed in g/mol, are calculated from their hydroxyl numbers and from their functionalities;
the molar masses of the polyamines (B1), expressed in g/mol, are calculated from their primary and/or total alkalinities, and from their functionality;
the molar masses (or average molar masses in the case of a mixture) of the polyamines (B2) are calculated from their chemical structures (¹H/¹³C NMR) and from their primary and/or secondary and/or tertiary and/or total alkalinities.

A first subject of the present invention relates to a composition, preferably an adhesive composition, comprising:
a composition A comprising at least one polyurethane comprising at least two acrylic end functions T of formula (I) below:

CH₂═CH—C(═O)—X— (I)
with X representing —O— or —NRₐ— with Rₐ representing H or an alkyl radical comprising from 1 to 22 carbon atoms, preferably from 1 to 14 carbon atoms, X preferably representing —O—;
and
a composition B comprising:
   at least one polyamine B1 comprising only two groups —CH₂NH₂; and
   at least one polyamine B2 comprising at least two primary amine functions —NH₂.

### A. Composition

Composition A

Composition A may comprise from 10% to 100% by weight of at least one abovementioned polyurethane comprising at least two end functions T, preferably from 20% to 95% by weight, more preferentially from 30% to 90% by weight and better still from 40% to 80% by weight, relative to the total weight of composition A.

The abovementioned polyurethane comprising at least two end functions T may be obtained by reaction:
of a polyurethane comprising at least two —NCO end functions and of at least one compound chosen from a hydroxylated ester of acrylic acid or a hydroxylated amide of acrylic acid; or
of a polyurethane comprising at least two —OH end functions and of at least one compound chosen from an acrylic acid chloride or an acrylic acid ester.

In the context of the invention, and unless otherwise mentioned, the term “hydroxylated ester of acrylic acid” means an acrylic acid ester in which the ester radical is substituted with at least one hydroxyl group. A hydroxylated ester of acrylic acid may be represented, for example, by the following formula:

CH₂═CH—C(═O)—O—R

in which R represents an organic radical substituted with at least one hydroxyl group.

According to one embodiment, the hydroxylated ester of acrylic acid has the formula (II) below:

CH₂═CH—C(═O)—O—R⁰—OH (II)

in which R⁰ represents a linear or branched, aliphatic or cyclic, saturated or unsaturated divalent hydrocarbon-based radical, preferably comprising from 2 to 240 carbon atoms and being optionally interrupted with one or more heteroatoms (for instance N, O, S, and in particular O), and/or optionally interrupted with one or more aromatic groups, and/or optionally interrupted with one or more divalent groups —N(R_{b})— with R_{b} representing a linear or branched alkyl radical comprising from 1 to 22 carbon atoms (tertiary amine), —C(═O)O— (ester), —C(═O)NH— (amide), —NHC(═O)O— (carbamate), —NHC(═O)—NH— (urea), or —C(═O)— (carbonyl), and/or being optionally substituted.

Preferably, the hydroxylated ester of acrylic acid has one of the following formulae:

Formula (II-1):

CH₂═CH—C(═O)—O—R¹—OH (II-1)

in which R¹ represents a linear or branched, aliphatic or cyclic, saturated or unsaturated divalent alkylene radical, comprising from 2 to 22 carbon atoms, preferably from 2 to 18, preferentially from 2 to 14, even more preferentially from 2 to 10 and advantageously from 2 to 6 carbon atoms;

Formula (II-2):

CH₂═CH—C(═O)—O—R²—O—[C(═O)—(CH₂)ᵣ—O]ₛ—H (II-2)

in which:
r is an integer ranging from 1 to 10, preferably from 1 to 5, and preferentially r is equal to 5;
s is an integer ranging from 1 to 10, s preferably being equal to 2;
R² represents a linear or branched, aliphatic or cyclic, saturated or unsaturated divalent alkylene radical, comprising from 2 to 22 carbon atoms, preferably from 2 to 18, preferentially from 2 to 14, even more preferentially from 2 to 10 and advantageously from 2 to 6 carbon atoms;

Formula (II-3):

CH₂═CH—C(═O)—O—[R³—O]ₜ—H (II-3)

in which R³ represents a linear or branched, aliphatic or cyclic, saturated or unsaturated divalent alkylene radical, comprising from 2 to 4 carbon atoms, t is an integer ranging from 2 to 120, preferably from 1 to 10, t preferably being equal to 2 or 3.

Among the hydroxylated esters of acrylic acid of formula (II-1), examples that may be mentioned include 2-hydroxyethyl acrylate (HEA), 2-hydroxypropyl acrylate (HPA), 4-hydroxybutyl acrylate (4-HBA) and 2-hydroxybutyl acrylate (HBA) (which are available, for example, from Sartomer, Cognis or BASF).

Among the compounds of formula (II-2) above, examples that may be mentioned include polycaprolactone acrylate SR 495B (CAPA) available from Sartomer or hydroxyethylcaprolactone acrylate (HECLA) available from BASF.

Among the ethoxylated and/or propoxylated derivatives of acrylic acid of the abovementioned formula (II-3), examples that may be mentioned include Blemmer® AP-150, Blemmer® AP-200, Blemmer® AP-400, Blemmer® AP-550, Blemmer ® AP-800, Blemmer®AP-1000, Blemmer® AE-90, Blemmer® AE-150, Blemmer® AE-200, Blemmer® AE-350 and Blemmer® AE-400, sold by Nippon Oil & Fats Corporation, or SR 604 from Sartomer.

Preferably, the hydroxylated ester of acrylic acid has the abovementioned formula (II-1), and in particular one of the formulae (II-1-1) or (II-1-2) below:

CH₂═CH—C(═O)—O—CH₂—CH₂—OH (II-1-1): 2-hydroxyethyl acrylate (HEA);

CH₂═CH—C(═O)—O—CH₂—CH(Me)—OH (II-1-2): 2-hydroxypropyl acrylate (HPA).

In the context of the invention, and unless otherwise mentioned, the term “hydroxylated amide of acrylic acid” means an acrylic acid amide in which the amide radical is substituted with at least one hydroxyl group. A hydroxylated amide of acrylic acid may be represented, for example, by the following formula:

CH₂═CH—C(═O)—N(Rₐ)-R′

in which R′ represents an organic radical substituted with at least one hydroxyl group, and Rₐ representing H or an alkyl radical comprising from 1 to 22 carbon atoms, preferably from 1 to 18, preferentially from 1 to 14, advantageously from 1 to 10 and even more advantageously from 1 to 6 carbon atoms.

According to one embodiment, the hydroxylated amide of acrylic acid has the formula (II′) below:

CH₂═CH—C(═O)—N(Rₐ)-R′¹—OH (II′-1)
in which Rₐ is as defined above, and R′¹ represents a linear or branched, aliphatic or cyclic, saturated or unsaturated divalent hydrocarbon-based radical, preferably comprising from 1 to 240 carbon atoms and being optionally interrupted with one or more heteroatoms (for instance N, O, S, and in particular O), and/or optionally interrupted with one or more aromatic groups, and/or optionally interrupted with one or more divalent groups —N(R_{b})— with R_{b} being as defined above (tertiary amine), —COO— (ester), —C(═O)NH— (amide), —NHC(═O)O— (carbamate), —NHC(═O)—NH— (urea), or —C(═O)— (carbonyl), and/or being optionally substituted.

According to one embodiment, the hydroxylated amide of acrylic acid has one of the following formulae:

Formula (II′-1):

CH₂═CH—C(═O)—N(Rₐ)—R′¹—OH (II′-1)

in which Rₐ is as defined previously, and R′¹ represents a linear or branched, aliphatic or cyclic, saturated or unsaturated divalent alkylene radical, comprising from 1 to 22 carbon atoms, preferably from 1 to 18, preferentially from 1 to 14, even more preferentially from 1 to 10 and advantageously from 1 to 6 carbon atoms;

Formula (II′-2):

CH₂═CH—(═O)—N(Rₐ)-R′²—O—[C(═O)—(CH₂)ᵣ—O]ₛ—H (II′-2)

in which:
Rₐ is as defined previously;
r′ is an integer ranging from 1 to 10, preferably from 1 to 5, and preferentially r is equal to 5;
s′ is an integer ranging from 1 to 10, s preferably being equal to 2;
R′² represents a linear or branched, aliphatic or cyclic, saturated or unsaturated divalent alkylene radical, comprising from 2 to 22 carbon atoms, preferably from 2 to 18, preferably from 2 to 14, preferentially from 2 to 10 and advantageously from 2 to 6 carbon atoms;

Formula (II′-3):

CH₂═CH—C(═O)—N(Ra)₄R³—O]_{t′}—H (II′-3)

in which Rₐ is as defined previously, and R′³ represents a linear or branched, aliphatic or cyclic, saturated or unsaturated divalent alkylene radical, comprising from 2 to 4 carbon atoms, t′ is an integer ranging from 2 to 120, preferably from 1 to 10, t preferably representing 2 or 3.

Preferably, the hydroxylated amide of acrylic acid has the abovementioned formula (II′-1), and in particular one of the formulae (II′-1-1) or (II′-1-2) below:

CH₂═CH—C(═O)—NH—CH₂—CH₂—OH (II′-1-1): 2-hydroxyethylacrylamide;

CH₂═CH—C(═O)—NH—CH₂—CH(Me)—OH (II′-1-2): 2-hydroxypropylacrylamide.

According to a first embodiment, the abovementioned polyurethane comprising at least two end functions T is prepared by reacting a polyurethane comprising at least two —OH end functions; and at least one acrylic acid chloride or at least one acrylic acid ester.

In particular, the abovementioned polyurethane comprising at least two end functions

T is prepared according to a process comprising the following steps:
E′1) the preparation of a polyurethane bearing OH end groups via a polyaddition reaction:
   i) of at least one polyisocyanate, preferably chosen from diisocyanates, triisocyanates, and mixtures thereof;
   ii) with at least one polyol, preferably chosen from polyester polyols, polyether polyols, polyene polyols, polycarbonate polyols, poly(ether-carbonate) polyols, polymers bearing —OH end groups, and mixtures thereof,
      in amounts such that the NCO/OH mole ratio (r1) is strictly less than 1, preferably ranges from 0.2 to 0.8 and preferentially ranges from 0.3 to 0.5;
and
E′2) the reaction of the product formed on conclusion of step E′1) with the acrylic acid chloride or with an acrylic acid ester, in amounts such that the OH/—C(═O)X′ mole ratio (with X′ representing Cl or O) (r2) is less than or equal to 1, preferably ranges from 0.90 to 1.00 and preferentially ranges from 0.95 to 1.00.

In the context of the invention, and unless otherwise mentioned, (r1) is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E′1).

In the context of the invention, and unless otherwise mentioned, (r2) is the OH/—C(═O)X′ mole ratio (with X′ representing Cl or O) corresponding to the mole ratio of the number of hydroxyl groups (OH) to the number of —C(═O)—Cl (acid chloride) groups or —C(═O)—O (ester) groups borne, respectively, by all of the alcohol compounds (polyurethane bearing —OH end groups obtained on conclusion of step E′1) and optionally the polyol(s) which have not reacted on conclusion of step E′1)), and acrylic derivatives(s) (acrylic acid chloride or acrylic acid ester present in the reaction medium of step E′2).

According to a second embodiment, the abovementioned polyurethane comprising at least two end functions T is prepared by reacting a polyurethane comprising at least two —NCO end functions; and at least one hydroxylated ester of acrylic acid as defined above or at least one hydroxylated amide of acrylic acid as defined above.

Preferably, the abovementioned polyurethane comprising at least two end functions T is prepared via a process comprising the following steps:
E1) the preparation of a polyurethane bearing NCO end groups via a polyaddition reaction:
   i) of at least one polyisocyanate, preferably chosen from diisocyanates, triisocyanates, and mixtures thereof;
   ii) with at least one polyol, preferably chosen from polyester polyols, polyether polyols, polyene polyols, polycarbonate polyols, poly(ethercarbonate) polyols, polymers bearing —OH end groups, and mixtures thereof;
      in amounts such that the NCO/OH mole ratio (r3) is strictly greater than 1, preferably ranges from 1.3 to 2.0 and preferentially ranges from 1.5 to 1.7;
and
E2) the reaction of the product formed on conclusion of step E1) with at least one hydroxylated ester of acrylic acid as defined above (preferably of the abovementioned formulae (II-1-1) or (II-1-2)) or at least one hydroxylated amide of acrylic acid as defined above (preferably of the abovementioned formula (II′-1-1) or (II′-1-2)), in amounts such that the OH/NCO mole ratio (r4) is less than or equal to 1, preferably ranges from 0.90 to 1.00 and preferentially ranges from 0.95 to 1.00.

Preferentially, step E2) is performed with at least one hydroxylated ester of acrylic acid as defined above, preferably of the abovementioned formulae (II-1-1) or (II-1-2).

In the context of the invention, and unless otherwise mentioned, (r3) is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E1).

When the polyurethane bearing NCO end groups is obtained during step E1) from a mixture of polyisocyanates or of several polyisocyanates added successively, the calculation of the ratio (r3) takes into account firstly the NCO groups borne by all of the polyisocyanate(s) present in the reaction medium of step E1), and secondly the OH groups borne by the polyol(s) present in the reaction medium of step E1).

In the context of the invention, and unless otherwise mentioned, (r4) is the OH/NCO mole ratio corresponding to the mole ratio of the number of hydroxyl groups (OH) to the number of isocyanate groups (NCO) borne, respectively, by all of the alcohol(s) and of the isocyanate(s) (as notably regards the polyurethane bearing NCO end groups and optionally the polyisocyanate(s) which have not reacted on conclusion of step E1)), present in the reaction medium of step E2).

### Step E1) and E′1)

Polyol(s)

The polyol(s) used according to the invention may be chosen from those whose number-average molecular mass (Mn) ranges from 200 to 20000 g/mol, preferably from 300 to 12000 g/mol and preferentially from 400 to 4000 g/mol.

Preferably, their hydroxyl functionality ranges from 2 to 6, preferentially from 2 to 3. The hydroxyl functionality is the mean number of hydroxyl functions per mole of polyol.

Preferably, the polyol(s) that may be used according to the invention have a hydroxyl number (OHN) ranging from 5 to 840 milligrams of KOH per gram of polyol (mg KOH/g), preferably from 9 to 560 mg KOH/g, preferably from 28 to 420 mg KOH/g, more preferably from 100 to 400 mg KOH/g.

According to a particular embodiment, the hydroxyl number of polyol(s) having a hydroxyl functionality of 2 ranges from 5 to 560 mg KOH/g, preferably from 9 to 374 mg KOH/g, preferably from 28 to 280 mg KOH/g, more preferably from 100 to 280 mg KOH/g.

According to one embodiment, the hydroxyl number of polyol(s) having a hydroxyl functionality of 3 ranges from 8 to 840 mg KOH/g, preferably 14 to 560 mg KOH/g, preferably from 42 to 420 mg KOH/g, more preferably from 200 to 400 mg KOH/g.

The polyol(s) that can be used may be chosen from polyester polyols, polyether polyols, polyene polyols, polycarbonate polyols, poly(ether-carbonate) polyols, polymers having —OH end groups, and mixtures thereof.

The polyol(s) that can be used may be chosen from aromatic polyols, aliphatic polyols, arylaliphatic polyols, and mixtures of these compounds.

According to the invention, the polyester polyol(s) may have a number-average molecular mass ranging from 1000 g/mol to 10000 g/mol, preferably from 1000 g/mol to 6000 g/mol.

The polyester polyols may be chosen from polyester diols and polyester triols, and preferably from polyester diols.

Among the polyester polyols, examples that may be mentioned include:
polyester polyols of natural origin, such as castor oil;
polyester polyols resulting from the polycondensation:
   of one or more aliphatic (linear, branched or cyclic) or aromatic polyols, for instance monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with
   one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer, and mixtures of these acids, an unsaturated anhydride, for instance maleic or phthalic anhydride, or a lactone, for instance caprolactone.
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols may be prepared conventionally and are for the most part commercially available.

Among the polyester polyols, examples that may be mentioned include the following products with a hydroxyl functionality equal to 2:
Tone® 0240 (sold by Union Carbide), which is a polycaprolactone with a number-average molecular mass of about 2000 g/mol and a melting point of about 50° C.,
Dynacoll® 7381 (sold by Evonik) with a number-average molecular mass of about 3500 g/mol and a melting point of about 65° C.,
Dynacoll® 7360 (sold by Evonik), which results from the condensation of adipic acid with hexanediol and has a number-average molecular mass of about 3500 g/mol and a melting point of about 55° C.,
Dynacoll® 7330 (sold by Evonik) with a number-average molecular mass of about 3500 g/mol and a melting point of about 85° C.,
Dynacoll® 7363 (sold by Evonik), which also results from the condensation of adipic acid with hexanediol and has a number-average molecular mass of about 5500 g/mol and a melting point of about 57° C.,
Dynacoll® 7250 (sold by Evonik): polyester polyol with a viscosity of 180 Pa·s at 23° C., a number-average molecular mass Mn equal to 5500 g/mol and a T_{g} equal to −50° C.,
Kuraray® P-6010 (sold by Kuraray): polyester polyol with a viscosity of 68 Pa·s at 23° C., a number-average molecular mass Mn equal to 6000 g/mol and a T_{g} equal to −64° C.,
Kuraray® P-10010 (sold by Kuraray): polyester polyol with a viscosity of 687 Pa·s at 23° C. and a number-average molecular mass Mn equal to 10000 g/mol,
Realkyd® XTR 10410 (sold by the company Cray Valley): polyester polyol with a number-average molecular mass Mn in the region of 1000 g/mol and the hydroxyl number of which ranges from 108 to 116 mg KOH/g. It is a product resulting from the condensation of adipic acid, diethylene glycol and monoethylene glycol,
Dekatol® 3008 (sold by the company Bostik) with a number-average molar mass Mn in the region of 1060 g/mol and the hydroxyl number of which ranges from 102 to 112 mg KOH/g. It is a product resulting from the condensation of adipic acid, diethylene glycol and monoethylene glycol.

According to the invention, the polyether polyol(s) may have a number-average molecular mass ranging from 200 to 20000 g/mol, preferably from 300 to 12000 g/mol and preferentially from 400 to 4000 g/mol.

The polyether polyol(s) that may be used according to the invention are preferably chosen from polyoxyalkylene polyols, the linear or branched alkylene portion of which comprises from 1 to 4 carbon atoms, more preferentially from 2 to 3 carbon atoms.

More preferentially, the polyether polyol(s) that may be used according to the invention are preferably chosen from polyoxyalkylene diols or polyoxyalkylene triols, the linear or branched alkylene portion of which comprises from 1 to 4 carbon atoms, more preferentially from 2 to 3 carbon atoms.

As examples of polyoxyalkylene diols or triols that may be used according to the invention, mention may be made of:
polyoxypropylene diols or triols (also denoted by polypropylene glycol (PPG) diols or triols) having a number-average molecular mass (Mn) ranging from 300 to 12000 g/mol;
polyoxyethylene diols or triols (also denoted by polyethylene glycol (PEG) diols or triols) having a number-average molecular mass (Mn) ranging from 300 to 12000 g/mol;
and mixtures thereof.

The abovementioned polyether polyols may be prepared conventionally and are widely available commercially. They may be obtained by polymerization of the corresponding alkylene oxide in the presence of a basic catalyst (for example potassium hydroxide) or of a catalyst based on a double metal/cyanide complex.

As examples of polyether diols, mention may be made of the polyoxypropylene diol sold under the name Voranol® P 400 by the company Dow, with a number-average molecular mass (Mn) in the region of 400 g/mol and the hydroxyl number of which ranges from 250 to 270 mg KOH/g.

As examples of polyether triols, mention may be made of the polyoxypropylene triol sold under the name Voranol® CP 450 by the company Dow, with a number-average molecular mass (Mn) in the region of 450 g/mol and the hydroxyl number of which ranges from 370 to 396 mg KOH/g, or the polyoxypropylene triol sold under the name Voranol® CP3355 by the company Dow, with a number-average molecular mass in the region of 3554 g/mol.

The polyene polyol(s) that may be used according to the invention may preferably be chosen from polyenes including hydroxyl end groups, and the corresponding hydrogenated or epoxidized derivatives thereof.

Preferably, the polyene polyol(s) that may be used according to the invention are chosen from polybutadienes including hydroxyl end groups, which are optionally hydrogenated or epoxidized. Preferentially, the polyene polyol(s) that may be used according to the invention are chosen from butadiene homopolymers and copolymers including hydroxyl end groups, which are optionally hydrogenated or epoxidized.

In the context of the invention, and unless otherwise mentioned, the term “hydroxyl end groups” of a polyene polyol means the hydroxyl groups located at the ends of the main chain of the polyene polyol.

The hydrogenated derivatives mentioned above may be obtained by total or partial hydrogenation of the double bonds of a polydiene including hydroxyl end groups, and are thus saturated or unsaturated.

The epoxidized derivatives mentioned above may be obtained by chemoselective epoxidation of the double bonds of the main chain of a polyene including hydroxyl end groups, and thus include at least one epoxy group in its main chain.

Examples of polyene polyols that may be mentioned include saturated or unsaturated butadiene homopolymers comprising hydroxyl end groups, which are optionally epoxidized, for instance those sold under the name Poly BD® or Krasol® by the company Cray Valley.

The polycarbonate polyols may be chosen from polycarbonate diols or triols, in particular with a number-average molecular mass (Mₙ) ranging from 300 to 12000 g/mol.

Examples of polycarbonate diols that may be mentioned include:
Converge® Polyol 212-10 and Converge® Polyol 212-20 sold by the company Novomer, with respective number-average molecular masses (Mₙ) equal to 1000 and 2000 g/mol, the hydroxyl numbers of which are, respectively, 112 and 56 mg KOH/g,
Desmophen® C XP 2716 sold by Covestro, with a number-average molecular mass (Mₙ) equal to 326 g/mol, and the hydroxyl number of which is 344 mg KOH/g,
Polyol C-590, C1090, C-2090 and C-3090 sold by Kuraray, with a number-average molecular mass (Mₙ) ranging from 500 to 3000 g/mol and a hydroxyl number ranging from 224 to 37 mg KOH/g.

According to the invention, the polymers bearing —OH end groups may be obtained by polyaddition reaction between one or more polyol(s) and one or more polyisocyanate(s), in amounts of polyisocyanate(s) and of polyol(s) leading to an NCO/OH mole ratio strictly less than 1. The reaction may be performed in the presence of a catalyst. The polyols and polyisocyanates that can be used may be those typically used for the preparation of polymers bearing —OH end groups and preferably those described in the present patent application.

According to a preferred embodiment, step E1) is performed in the presence of a mixture of polyols, preferably comprising at least one polyether polyol and/or at least one polyester. Preferably, step E1) is performed in the presence of a mixture of at least two polyether polyols (preferably a polyether diol and a polyether triol) and of a polyester (preferably a polyester diol).

The abovementioned polyols may also be used in step E1) as defined previously.

Polyisocyanate(s)

The polyisocyanate(s) that may be used according to the invention in steps E1) or) E′1) may be added sequentially or reacted in the form of a mixture.

According to one embodiment, the polyisocyanate(s) that may be used are diisocyanate(s), preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl(meta)xylylene diisocyanate), an HDI allophanate having, for example, the formula (Y) below:

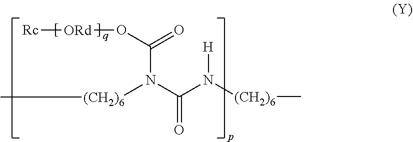

in which p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group;
and mixtures thereof.

Preferably, the allophanate of the abovementioned formula (Y) is such that p, q, R_{c} and R_{d} are chosen such that the above HDI allophanate derivative comprises a content of isocyanate groups NCO ranging from 12% to 14% by weight relative to the weight of said derivative.

According to one embodiment, the polyisocyanate(s) that may be used are triisocyanate(s), preferably chosen from isocyanurates, biurets and adducts of diisocyanates and of triols.

In particular, the isocyanurate(s) may be used in the form of a technical mixture of (poly)isocyanurate(s) with a purity of greater than or equal to 70% by weight of isocyanurate(s).

Preferably, the diisocyanate isocyanurate(s) that may be used according to the invention correspond(s) to the general formula (W) below:

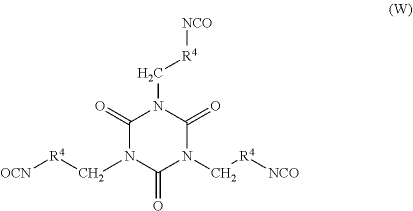

in which:

R⁴ represents a linear or branched, cyclic, aliphatic, arylaliphatic or aromatic alkylene group comprising from 4 to 9 carbon atoms,

with the proviso that the NCO groups are not connected via a covalent bond to a carbon atom forming part of an aromatic hydrocarbon-based ring, such as a phenyl group.

As examples of diisocyanate trimers that may be used according to the invention, mention may be made of:
the isocyanurate trimer of hexamethylene diisocyanate (HDI):

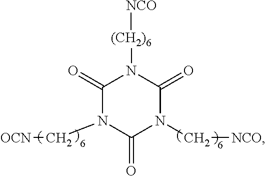

the isocyanurate trimer of isophorone diisocyanate (IPDI):

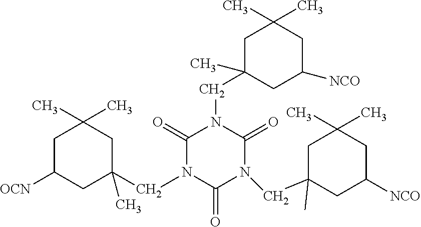

the isocyanurate trimer of pentamethylene diisocyanate (PDI):

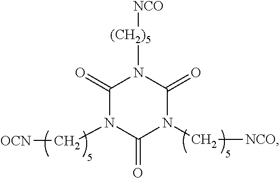

the isocyanurate trimer of meta-xylylene diisocyanate (m-XDI):

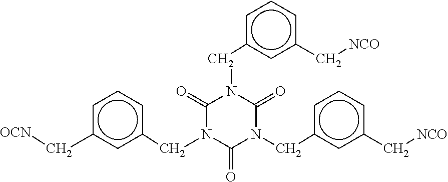

the isocyanurate trimer of m-XDI, in hydrogenated form:

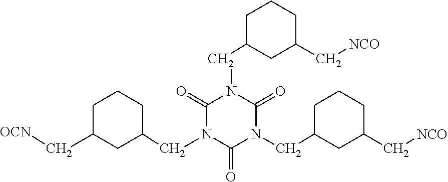

As examples of adducts of diisocyanates and of triols that may be used according to the invention, mention may be made of the adduct of meta-xylylene diisocyanate and of trimethylolpropane, as represented below. This adduct is sold, for example, by the company Mitsui Chemicals, Inc. under the name Takenate® D-110N.

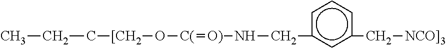

The polyisocyanate(s) that may be used to prepare the polyurethane used according to the invention are widely commercially available. By way of example, mention may be made of Scuranate® TX sold by the company Vencorex, corresponding to a 2,4-TDI having a purity of the order of 95%, Scuranate® T100 sold by the company Vencorex, corresponding to a 2,4-TDI having a purity of 99% by weight, Desmodur® I sold by the company Covestro, corresponding to an IPDI or Desmodur® N3300 sold by the company Covestro, corresponding to an HDI isocyanurate, Takenate™ 500 sold by Mitsui Chemicals, corresponding to an m-XDI, Takenate™ 600 sold by Mitsui Chemicals, corresponding to an m-H6XD1, Vestanat® H12MD1 sold by Evonik, corresponding to an H12MDI.

Preferably, the polyisocyanate(s) are chosen from toluene diisocyanate (in particular the isomer 2,4-TDI, the isomer 2,6-TDI or mixtures thereof), meta-xylylene, HDI isocyanurate, and mixtures thereof.

The abovementioned polyisocyanates may also be used in the abovementioned step E′1).

Reaction Conditions

The polyaddition reaction of step E1) and the reaction of step E′1) may be performed at a temperature preferably below 95° C. and/or preferably under anhydrous conditions.

The polyaddition reaction of step E1) and the reaction of step E′1) may be performed in the presence or absence of at least one reaction catalyst.

The reaction catalyst(s) that may be used during the polyaddition reaction of step E1) and the reaction of step E′1) may be any catalyst known to those skilled in the art for catalyzing the formation of polyurethane by reaction of at least one polyisocyanate with at least one polyol.

An amount ranging up to 0.3% by weight of catalyst(s) relative to the weight of the reaction medium of step E1) or E′1) may be used. In particular, it is preferred to use from 0.02% to 0.2% by weight of catalyst(s) relative to the weight of the reaction medium of step E1) or E′1).

### Step E2) and E′2)

In the presence of acrylic acid ester, the transesterification reaction of step E′2) may be performed at a temperature above 110° C., preferably above 120° C.

Among the acrylic acid esters, examples that may be mentioned include methyl acrylate, butyl acrylate, propyl acrylate and pentyl acrylate.

In the presence of acrylic acid chloride, the reaction of step E′2) may be performed at a temperature preferably below 95° C., preferably under anhydrous conditions.

In the presence of hydroxylated ester(s) of acrylic acid, or of hydroxylated amide(s) of acrylic acid or of acrylic acid chloride, the reaction of step E2) may be performed at a temperature preferably below 95° C., preferably under anhydrous conditions.

The hydroxylated esters of acrylic acid may be used either pure or in the form of a mixture of different hydroxylated esters of acrylic acid with a mean hydroxyl number of said mixture ranging from 56 to 483 mg KOH/g of said mixture.

The hydroxylated amides of acrylic acid may be used either pure or in the form of a mixture of different hydroxylated amides of acrylic acid with a mean hydroxyl number of said mixture ranging from 56 to 487 mg KOH/g of said mixture.

Step E2) is preferably performed with at least one hydroxylated ester of acrylic acid of the abovementioned formula (II), preferably of the abovementioned formulae (II-1) or (II-2) or (II-3), and in particular of the abovementioned formula (II-1-1) or (II-1-2), advantageously of the abovementioned formula (II-1-1).

Composition A may also comprise at least one solvent, preferably in an amount ranging from 10% to 50% by weight, more preferentially ranging from 15% to 40% by weight and better still ranging from 20% to 30% by weight, relative to the total weight of composition A.

The solvent may be chosen from organic solvents and alcoholic solvents such as ethyl acetate, methyl ethyl ketone, xylene, ethanol, isopropanol, tetrahydrofuran, methyltetrahydrofuran or else from Isane® (based on isoparaffins, available from the company Total) or Exxol® D80 (based on aliphatic hydrocarbons, available from the company ExxonMobil Chemical).

According to one embodiment, composition A has a viscosity, measured at room temperature (23° C.), ranging from 500 to 10000 mPa·s, preferably ranging from 1000 to 5000 mPa·s.

The polyurethane comprising at least two -NCO end functions preferably contains from 0.1 to 1.5 milliequivalents per gram of functions T of the abovementioned formula (I) per gram of said polyurethane, more preferentially from 0.4 to 1.2 milliequivalents of functions T per gram of said polyurethane, and advantageously from 0.4 to 1.0 milliequivalent of functions T per gram of said polyurethane.

According to a preferred embodiment, the abovementioned polyurethane comprises at least two end functions T of formula (I′) below:

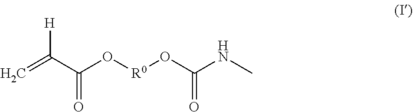

in which R⁰ is as defined previously, R⁰ preferably representing —CH₂CH₂— or —CH₂—CH(Me)—.

Composition B

Composition B comprises at least one polyamine B1 and at least one polyamine B2.

It goes without saying in the present invention that polyamine B1 and polyamine B2 of composition B are different.

Composition B may comprise:
one polyamine B1 and one polyamine B2;
a mixture of polyamines B1 and one polyamine B2;
one polyamine B1 and a mixture of polyamines B2;
a mixture of polyamines B1 and a mixture of polyamines B2.

Polyamine B1

Polyamine B1 comprises only two —CH₂—NH₂ groups, preferably at each end.

Thus, polyamine B1 does not comprise any —CH₂—NH₂ groups other than the two abovementioned groups. On the other hand, polyamine B1 may comprise other organic groups/radicals (different from —CH₂—NH₂).

Polyamine B1 may comprise several amine functions, including only two —CH₂—NH₂ groups.

According to one embodiment, polyamine B1 has the formula (III) below:

NH₂—CH₂—Z—CH₂—NH₂ (III)

in which Z represents a linear or branched, cyclic, aliphatic or aromatic, saturated or unsaturated divalent hydrocarbon-based radical, preferably comprising from 1 to 22 carbon atoms, said hydrocarbon-based radical being optionally interrupted with one or more heteroatoms chosen from —S—, —O— and/or one or more divalent tertiary amine groups —NR″′— with R″′ representing a linear or branched, saturated or unsaturated alkyl group, comprising 1 to 22 carbon atoms, preferably from 1 to 18, preferably from 1 to 14, preferentially from 1 to 10 and advantageously from 1 to 6 carbon atoms.

Preferably, polyamine B1 corresponds to one of the formulae (III-1), (III-2) or (III-3) below:

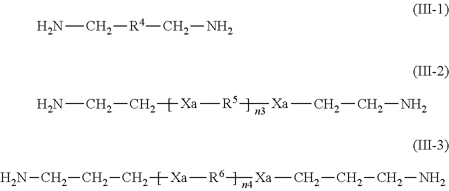

in which:
R⁴ is a linear or branched divalent alkylene radical, or a divalent arylene radical, comprising from 1 to 18 carbon atoms, R⁴ preferably representing a linear alkylene radical comprising 6, 10 or 12 carbon atoms;
R⁵ represents a linear or branched divalent alkylene radical comprising from 2 to 12 carbon atoms, preferentially of ethylene or propylene type,
R⁶ represents a linear or branched divalent alkylene radical comprising from 2 to 10 carbon atoms, preferentially of ethylene or propylene type,
Xₐ=O, S, NR′ in which R⁷ represents H or a linear or branched, saturated or unsaturated alkyl group comprising from 1 to 10 carbon atoms, preferentially 1 to 4 carbon atoms, X preferably representing O;
n₃ is an integer ranging from 0 to 4, and advantageously being equal to 1 or 2;
n₄ is an integer ranging from 0 to 2, and advantageously being equal to 1.

Polyamine B1 is preferably a polyamine of formula (III-2) above, in which Xₐ preferably represents O, and n₃ is preferably 1.

According to one embodiment, polyamine B1 has a primary alkalinity of greater than or equal to 7 meq./g, preferably greater than or equal to 10 meq./g, preferentially greater than or equal to 13 meq./g.

According to one embodiment, polyamine B1 has a primary alkalinity of between 7 and 34 meq./g, preferably between 9 and 34 meq./g and advantageously between 10 and 20 meq./g.

Preferably, polyamine B1 is chosen from diethylenetriamine (DETA): H₂N—CH₂—CH₂—NH—CH₂—CH₂—NH₂, 1,10-decanediamine: H₂N—(CH₂)₁₀—NH₂, 1,12-dodecanediamine: H₂N—(CH₂)₁₂—NH₂, 1,6-hexamethylenediamine (NMDA), the polyetherdiamines of formulae H₂N—CH₂—CH₂—O—CH₂—CH₂—O—CH₂—CH₂—NH₂ and H₂N—CH₂—CH₂—CH₂—O—CH₂—CH₂—O—CH₂—CH₂—CH₂—NH₂ (available, for example, under the respective trade names Jeffamine® EDR 148 and Jeffamine® EDR 176 from the company Huntsman).

Polyamine B2

Composition B comprises at least one polyamine B2 comprising at least two primary amine functions —NH₂.

According to one embodiment, polyamine B2 or the mixture of polyamines B2 has a primary alkalinity strictly less than 10.00 meq./g, preferably between 3.0 and less than 10.00 meq./g.

According to one embodiment, polyamine B2 is chosen from the group consisting of polyetheramines, polyamidoamines, fatty amine dimers or trimers, polyethyleneimines (PEI), polyethyleneimine dendrimers, polypropyleneimines (PPI), polypropyleneimine dendrimers, polyallylamines, poly(propylene-ethylene)imines, and mixtures thereof, said polyamine preferably having a primary alkalinity strictly less than 10.00 meq./g, preferably between 3.0 and less than 10.00 meq./g.

According to a preferred embodiment, polyamine B2 comprises at least two —CHR⁸—NH₂ groups (preferably from 2 to 6 groups) with R⁸ representing H or an alkyl radical preferably comprising from 1 to 4 carbon atoms, R⁸ preferably being H or methyl.

According to one embodiment, polyamine B2 is chosen from polyetheramines, in particular chosen from:
polyetherdiamines, for instance:
   polyetherdiamines corresponding to the formula below:

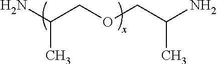

in which x is an integer such that the primary alkalinity of the polyetherdiamine is between 0.5 and less than 10 meq./g, x preferably ranging from 2 to 68 (such polyetherdiamines are sold, for example, under the name Jeffamines D-230, D-400, D-2000 and D-4000 by the company Huntsman and have respective primary alkalinities of 8.7, 5.0, 1.0 and 0.5 meq./g);
   polyetherdiamines corresponding to the formula below:

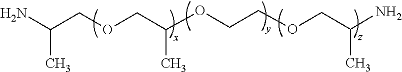

in which x, y and z are integers such that the primary alkalinity is between 1 and less than 10 meq./g, y preferably ranging from 2 to 39 and x+z ranging from 1 to 6 (such polyetherdiamines are sold, for example, under the name Jeffamines HK-511, ED-600, ED-900 and ED-2003 by the company Huntsman and have respective primary alkalinities of 9.1, 3.3, 2.2 and 1.0 meq./g);
   polyetherdiamines corresponding to the following formula:

H₂N—X_{b}(—O—X_{b})ₘ₋₁—O—(CH₂—CH₂—CH₂—CH₂—O)ₙ—(X_{b}—O)ₘ₋₁—X_{b}—H₂
in which X_{b} is a linear or branched alkylene group preferably comprising from 2 to 20 carbon atoms, preferably from 2 to 10 carbon atoms, m is an integer ranging from 1 to 20 and n is an integer ranging from 1 to 100, m and n preferably being such that the primary alkalinity of the polyetherdiamines is strictly less than 10 meq./g;
polyethertriamines, for instance those corresponding to the formula below:

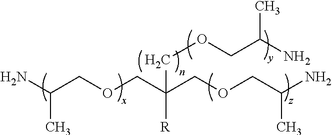

in which R is a hydrogen atom or a C1 to C2 alkyl group, x, y, z and n are integers such that the primary alkalinity of the polyethertriamine is between 0.5 and less than 10 meq./g, n preferably ranging from 0 to 1 and x+y+z ranging from 5 to 85 (such polyethertriamines are sold, for example, under the name Jeffamines T-403, T-3000, and T-5000 by the company Huntsman and have respective primary alkalinities of 6.8, 1.0 and 0.6 meq./g).

According to another embodiment, polyamine B2 is chosen from fatty amine dimers and trimers including two or three primary amine groups with a primary alkalinity ranging from 3.28 meq./g to 5.20 meq./g. These fatty amine dimers and trimers may be obtained from corresponding dimerized and trimerized fatty acids. As examples of such partially or totally hydrogenated fatty amine dimers, mention may be made of those corresponding to the following formulae:

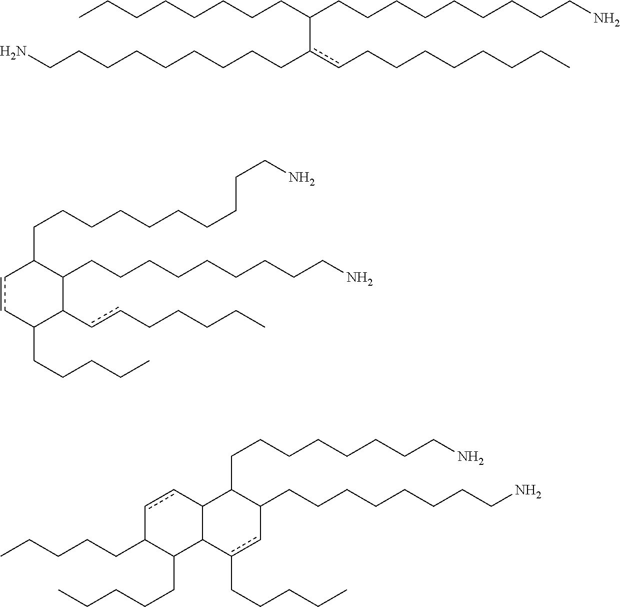

The fatty acid dimers and trimers used to prepare the abovementioned fatty amines may be obtained by high-temperature polymerization under pressure of unsaturated monocarboxylic fatty acids (monomeric acid) comprising from 6 to 22 carbon atoms, preferably from 12 to 20 carbon atoms, and originate from plant or animal sources. Examples of such unsaturated fatty acids that may be mentioned include C₁₈ acids containing one or two double bonds (respectively oleic acid or linoleic acid) obtained from tall oil, which is a byproduct of the manufacture of paper pulp. After polymerization of these unsaturated fatty acids, a technical mixture is notably obtained which contains, on average, 30-35% by weight of monocarboxylic fatty acids, often isomerized, with respect to the starting unsaturated monocarboxylic fatty acids, 60-65% by weight of dicarboxylic acids (dimeric acids) comprising twice the carbon number with respect to the starting unsaturated monocarboxylic fatty acids, and 5-10% by weight of tricarboxylic acids (trimeric acids) containing three times the carbon number with respect to the starting unsaturated monocarboxylic fatty acids. The different commercial grades of acid dimers, monomers or trimers are notably obtained by purification of this mixture. These fatty acid dimers and trimers are then typically subjected to a reductive ammoniation (NH₃/H₂) reaction in the presence of a catalyst, making it possible to obtain the dimerized fatty amines.

According to another embodiment, polyamine B2 is chosen from polyethyleneimines (PEI) preferably with a number-average molecular mass (Mn) ranging from 450 to 25 000 g/mol and a primary alkalinity/total alkalinity ratio ranging from 0.35 to 0.45, and in particular containing at least one radical having the following formula:

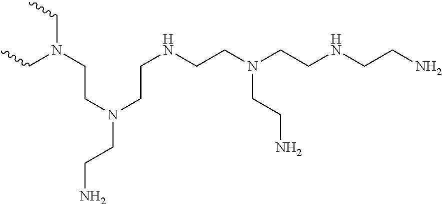

Examples that may be mentioned include the polyethyleneimines sold under the name Lupasol sold by BASF, such as Lupasol FG of Mn=800 g/mol with a primary amine/secondary amine/tertiary amine mole ratio=1.0/0.9/0.5 determined by ¹³C NMR, a calculated primary alkalinity=9.75 meq./g and a primary alkalinity/total alkalinity ratio=0.42.

Preferably, polyamine B2 is chosen from polyetheramines, polyethyleneimines (PEI) as defined above, and mixtures thereof.

According to one embodiment, composition B has a primary alkalinity/total alkalinity ratio ranging from 0.25 to 1.00.

The polyamine(s) B1/polyamine(s) B2 mass ratio in composition B may range from 90/10 to 10/90, preferably from 80/20 to 20/80, preferentially from 30/70 to 70/30, even more preferentially from 60/40 to 40/60 and better still is about 50/50.

Composition B may be prepared by simple mixing of the constituents, preferably at a temperature ranging from 10° C. to 50° C., preferably at room temperature, preferably using a mechanical mixer before or without addition of solvent.

Composition

According to one embodiment of the invention, the (NH₂+NH)/functions T mole ratio (denoted r5) in the composition ranges from 0.2 to 1.5, preferably from 0.4 to 1.2, preferentially from 0.5 to 1.1.

The mole ratio (r5) is the mole ratio of the sum of the number of primary amine functions (NH₂) and of the number of secondary amine functions (NH) on the functions T.

Preferably, the composition according to the invention is an adhesive composition.

According to one embodiment of the invention, the mass ratio A/B between composition A and composition B, in the composition, ranges from 100/1 to 100/50, preferably 100/2 to 100/30, preferentially from 100/2 to 100/10 and even more advantageously from 100/2 to 100/5.

The composition according to the invention may comprise at least one crosslinking catalyst. The crosslinking catalyst may be present in composition A and/or in composition B, preferably in composition A.

The crosslinking catalyst(s) may be any catalyst usually used to accelerate the addition reaction of a compound including a primary amine to a compound including an acrylate group.

According to one embodiment, the catalyst is chosen from the group consisting of Lewis bases and Brønsted bases, the conjugate acids of which have a pKa≥10, hydroxides (for instance LiOH, NaOH or KOH), hydrides (for instance NaH, KH or CaH₂), carbonates (for instance CaCO₃, Na₂CO₃ or K₂CO₃), alkali metal alkoxides (for instance sodium methoxide, potassium methoxide, sodium ethoxide, potassium tert-butoxide, titanium tetraisopropoxide), and mixtures thereof.

The Lewis bases and Brønsted bases whose conjugate acids have a pKa≥10 may typically be those described in Houben-Weyl, vol. XI/1, (1957), page 277 ff. and in Patai, “The Chemistry of the Amino Group, pages 61-65, Interscience, New York (1968).

Preferably, the Lewis bases are chosen from the group consisting of cycloaliphatic amines, such as 1,4-diazabicyclo[2.2.2]octane (DABCO) or 2,2′-dimorpholinodiethyl ether (DMDEE); aliphatic tertiary amines, for instance triethylamine, tripropylamine, tributylamine, N-methyldiethanolamine, N-methyldiisopropylamine or N-butyldiethanolamine; amidines, for instance 1,5-diazabicyclo[4.3.0]non-5-ene (DBN), 1,8-diazabicyclo[5.4.0]undec-7-ene (DBU); guanidines, for instance N,N,N′,N′-tetramethylguanidine, 1,5,7-triazabicyclo[4.4.0]dec-5-ene (TBD) or N-methyl triazabicyclodecene (Me-TBD); copolymers of 2,3,4-vinylpyridine or of amine acrylates such as 2-dimethylaminoethyl acrylate, 2-diethylaminoethyl acrylate or 3-dimethylaminopropyl acrylate; phosphazenes, for instance 2-tert-butylimino-2-diethylamino-1,3-dimethylperhydro-1,3,2-diazaphosphoride (BMEP); alkyl or aryl alkyl phosphanes, for instance tributylphosphane, triphenylphosphane, tris-p-tolylphosphane, methyldiphenylphosphane; hydroxy and amino phosphanes; basic ion-exchange resins; and mixtures thereof.

Among the Lewis bases that are particularly preferred according to the invention, mention may be made of:

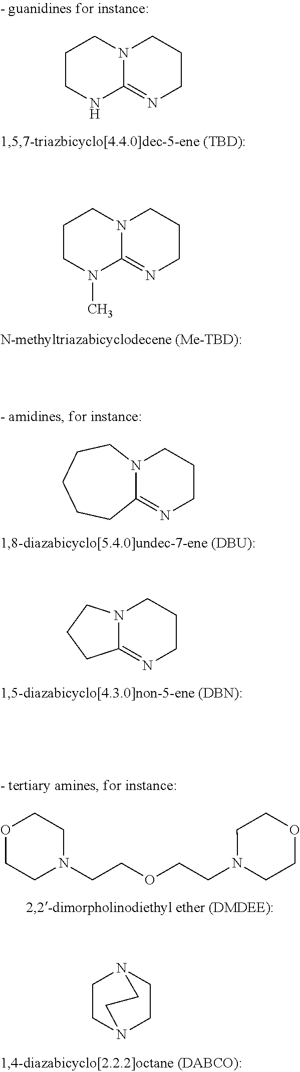 [SMILES: C1CN=C2NCCCN2C1 ; CN1CCCN2CCCN=C12 ; C1CCC2=NCCCN2CC1 ; C1CN=C2CCCN2C1 ; C1CN(CCOCCN2CCOCC2)CCO1 ; C1CN2CCN1CC2]

An amount ranging from 0.05% to 5% by weight, preferentially from 0.1% to 3% by weight of crosslinking catalyst(s) relative to the total weight of the composition according to the invention may be added.

The crosslinking catalyst(s) may be distributed in one or more of the compositions (for example in composition A and/or in composition B defined above) forming the composition according to the invention, preferentially in composition B.

The composition according to the invention may also comprise at least one mineral filler, preferably in an amount not exceeding 70% by weight relative to the weight of the composition. The filler(s) may be present in composition A and/or in composition B.

The mineral filler(s) that may be used are advantageously chosen so as to improve the mechanical performance of the composition according to the invention in the crosslinked state.

As examples of fillers that may be used, mention may be made, in a nonlimiting manner, of calcium carbonate, kaolin, silica, gypsum, microspheres and clays.

Preferably, the mineral filler(s) have a maximum particle size, notably an outside diameter, of less than 100 μm and preferably less than 10 μm. Such fillers may be selected, in a manner well known to a person skilled in the art, by using sieves having appropriate mesh sizes.

The composition according to the invention may also comprise at least one adhesion promoter preferably chosen from silanes, aminosilanes or acryloylsilanes. The adhesion promoter(s) may be present in composition A and/or in composition B, preferably in composition A.

The composition according to the invention may include less than 2% by weight of one or more additives advantageously appropriately chosen so as not to damage the properties of the adhesive composition according to the invention in the crosslinked state. Among the additives that may be used, examples that may be mentioned include antioxidants or UV (ultraviolet) stabilizers, pigments and dyes. These additives are preferably chosen from those generally used in adhesive compositions.

The additive(s) may be distributed in one or more of the compositions forming the composition according to the invention.

### B. Ready-to-Use Kit

The present invention also relates to a ready-to-use kit, comprising composition A as defined above, on the one hand, and composition B as defined above, on the other hand, packaged in two separate compartments.

Specifically, the composition according to the invention may be in a two-pack form, for example in a ready-to-use kit, comprising composition A, on the one hand, in a first compartment or drum and composition B, on the other hand, in a second compartment or drum, in proportions suitable for direct mixing of the two compositions, for example by means of a metering pump.

According to one embodiment of the invention, the kit also comprises one or more means for mixing the two compositions A and B. Preferably, the mixing means are chosen from metering pumps and static mixers of diameter suited to the amounts used.

### C. Multilayer (Complex) Structure

A subject of the present invention is also a multilayer (complex) structure comprising at least two layers of material bonded together by an adhesive layer, characterized in that said adhesive layer consists of the composition according to the invention in the crosslinked state.

The adhesive layer preferably has a thickness ranging from 1.5 to 5 μm.

The adhesive layer may be obtained by crosslinking the composition according to the invention in an amount preferably ranging from 1.5 to 5 g/m².

The materials of which the layers of material surrounding the adhesive layer are made are generally chosen from paper, metal, for instance aluminum, or thermoplastic polymers such as:
polyethylene (PE),
polypropylene (PP),
a copolymer based on ethylene and propylene,
polyamide (PA),
polyethylene terephthalate (PET), or else
a copolymer based on ethylene, for instance a maleic anhydride-grafted copolymer, a copolymer of ethylene and of vinyl acetate (EVA), a copolymer of ethylene and of vinyl alcohol (EVOH) or a copolymer of ethylene and of an alkyl acrylate, such as methyl acrylate (EMA) or butyl acrylate (EBA),
polystyrene (PS),
polyvinyl chloride (PVC),
polyvinylidene fluoride (PVDF),
a polymer or copolymer of lactic acid (PLA), or
a polyhydroxyalkanoate (PHA).

An individual layer of material may itself consist of several materials. It may be, for example, a layer of thermoplastic polymers obtained by coextrusion of two polymers (there is then no adhesive between the coextruded layers), the individual layers of thermoplastic polymer may also be coated with a substance (for example based on aluminum oxide or silicon oxide) or metallized (in the case of PET metallized with aluminum particles) to add an additional barrier effect.

The thickness of the two layers of material adjacent to the adhesive layer and of the other layers of material used in the multilayer structure according to the invention may vary within a wide range extending, for example, from 5 to 150 μm. The total thickness of said structure may also be liable to vary within a wide range extending, for example, from 20 to 400 μm.

Preferably, the multilayer structure is in the form of a multilayer film.

### D. Complexing Process

A subject of the invention is also a process for manufacturing the multilayer (complex) structure according to the invention, comprising the following steps:
mixing composition A and composition B, then
coating said mixture over the surface of a first layer, then
laminating the surface of a second layer over said coated surface, then
crosslinking said mixture.

The step of mixing composition A and composition B may be performed at room temperature or with heating, before coating.

Preferably, the mixing is performed at a temperature below the decomposition temperature of the ingredients included in one or other of compositions (A) and (B). In particular, the mixing is performed at a temperature below 95° C., preferably ranging from 15 to 80° C., more preferably ranging from 25° C. to 50° C., in order to avoid any thermal decomposition.

According to one embodiment of the invention, the NH₂+NH/functions T mole ratio (denoted r5) in the composition ranges from 0.2 to 1.5, preferably from 0.4 to 1.2, preferentially from 0.5 to 1.1.

According to one embodiment, when a solvent is present in compositions A and/or B and/or when a solvent is added during the mixing of composition A and of composition B, then the complexing process comprises a step of evaporating the solvent(s); said solvent evaporation step is then performed before crosslinking the mixture, preferably before the laminating step.

Said mixture may be coated onto all or part of the surface of a material. In particular, said mixture may be coated in the form of a layer with a thickness ranging from 1.5 to 5 μm. The coating is preferably performed continuously or substantially continuously.

Optionally, the crosslinking of said mixture on the surface of the material can be accelerated by heating the coated material(s) to a temperature of less than or equal to 70° C. The time required to complete this crosslinking reaction and to thus ensure the required level of cohesion is generally of the order of 0.5 to 24 hours.

The coating and laminating of the second material are generally performed within a time interval that is compatible with the coating process, as is well known to a person skilled in the art, that is to say before the adhesive layer loses its ability to attach the two materials by adhesive bonding.

### E. Use of the Multilayer Structure

The invention also relates to the use of the multilayer (complex) structure according to the invention for the manufacture of flexible packagings. Specifically, the complexes according to the invention may be used for the manufacture of very varied flexible packagings, which are formed and then closed (after the step of packaging the product intended for the consumer) via heat-sealing (or heat-welding) techniques.

In particular, the complex according to the invention may be used in food packaging, without any risk of toxicity. The packagings intended for foodstuffs are generally heat-treated at temperatures ranging from 60° C. to 135° C. before use. In particular, they may be pasteurized (at temperatures ranging from 90° C. to 95° C.) or sterilized (at temperatures ranging from 128° C. to 135° C.).

The multilayer structure according to the invention advantageously has very good heat resistance, in particular with respect to the sterilization or pasteurization test. In particular, the multilayer structure is advantageously suitable for manufacturing flexible wrappings intended for packaging food products.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” includes in particular the values 0% and 25%.

The invention is now described in the following implementation examples which are given purely by way of illustration and should not be interpreted in order to limit the scope thereof.

### EXAMPLES

The following ingredients were used:

### Composition A

Voranol® P 400: difunctional polypropylene glycol with a hydroxyl number OHN ranging from 250 to 270 mg KOH/g (available from the company Dow);
Voranol® CP 450: trifunctional polypropylene glycol with a hydroxyl number OHN ranging from 370 to 396 mg KOH/g (available from the company Dow);
Dekatol® 3008: difunctional polyester polyol with a hydroxyl number OHN ranging from 102 to 110 mg KOH/g (available from the company Bostik);
Scuranate® TX: toluene diisocyanate (TDI) containing 48.1% by weight of NCO functions and comprising 95% by weight of 2,4-TDI isomer (available from the company Vencorex);
2-hydroxyethyl acrylate (HEA): glyceryl carbonate with a purity of 98.5% by weight and containing 250±50 ppm of HQME (available from the company BASF);
ethyl acetate: solvent;
Borchi KAT® 315: catalyst based on bismuth neodecanoate (available from the company Borchers).

The polyol(s) were dried before being reacted with the polyisocyanate(s) used for the synthesis of the polyurethane bearing NCO end groups.

### Composition B

Jeffamine® D-230 (available from the company Huntsman): diamine (of B2 type) corresponding to the formula H₂N—(CHMe—CH₂—O—)ₙ—CH₂—CHMe—NH₂, having a molar mass of 230 g/mol, a primary and total alkalinity of 8.70 meq./g and a primary alkalinity/total alkalinity ratio of 1.00 determined by potentiometry;
Jeffamine® EDR-148 (available from the company Huntsman): diamine (of B1 type) corresponding to the formula H₂N—CH₂—CH₂—O—CH₂—CH₂—O—CH₂—CH₂—NH₂, having a molar mass of 148 g/mol, a primary and total alkalinity of 13.50 meq./g and a primary alkalinity/total alkalinity ratio of 1.00 determined by potentiometry;
Lupasol® FG (available from the company BASF): polyamine (of B2 type) of polyethylenimine (PEI) type with a molar mass of 800 g/mol, a sum of the primary alkalinity and of the secondary alkalinity of 19.0 meq./g, a primary alkalinity/total alkalinity ratio of 0.42 and a secondary alkalinity/total alkalinity ratio of 0.38 determined by ¹³C NMR, i.e. a ratio of the sum of the primary alkalinity and of the secondary alkalinity/total alkalinity of 0.79.

### Example 1

### Preparation of a Composition A-1 Based on a Polyurethane Bearing End Groups T Based on Polyether Polyols and Polyester Polyols

191.8 g of Scuranate® TX are placed in a reactor and heated to 40° C. 22.8 g of Voranol® CP 450 and then 104.5 g of Voranol® P 400 are then introduced in turn, taking care to ensure that the temperature of the mixture does not exceed 80° C. When the temperature of the mixture has stabilized, the mixture is heated for about 1 hour at 80-85° C. and is then cooled to 70° C. 323.5 g of Dekatol® 3008 are then introduced, taking care to ensure that the temperature of the mixture does not exceed 90° C.

The mixture is maintained at 90° C. for about 3 hours. The end of the reaction is monitored by controlling the mass percentage of NCO functions in the medium, this percentage needing to be in theory about 5.9% by weight. When the reaction is complete, the mixture is cooled to 70° C. and 107.0 g of 2-hydroxyethyl acrylate and 0.5 g of Borchi KAT® 315 are introduced. 100 g of ethyl acetate are added and the mixture is then maintained at 70° C. for 6 to 8 hours until no more NCO functions are visible on infrared (IR) (disappearance of the characteristic band of the NCO function at about 2250 cm⁻¹).

When the mass percentage of NCO functions is less than 0.1% (no more NCO band visible), 150 g of ethyl acetate are added. The viscosity of composition A-1 thus obtained is measured on D+1, i.e. 24 hours after the end of the reaction (disappearance of the NCO band visible in IR), using a Brookfield viscometer (needle No. 3, 20 rpm). The viscosity of composition A-1 at 23° C. is about 1200 mPa·s.

The content of functions T of the polyurethane bearing end groups T is about 0.92 meq./g for a solids content of 75%.

### Example 2

### Preparation of a Composition A-2 Based on a Polyurethane Bearing End Groups T Based on Polyether Polyols and Polyester Polyols

153.0 g of Scuranate® TX are placed in a reactor and heated to 40° C.

85.2 g of Voranol® P 400 are introduced slowly and the mixture is heated to 50° C. The reaction mass rises exothermically to about 70° C. Once the exotherm is controlled, the mixture is maintained at 70° C. After 1 hour of reaction, 393.0 g of Dekatol® 3008 are added. The reaction mass rises exothermically to about 85° C. The mixture is maintained at 85° C. for about 2-3 hours. The end of the reaction is monitored by controlling the mass percentage of NCO functions in the medium, this percentage needing to be in theory about 3.8% by weight. When the reaction is complete, the mixture is cooled to 70° C. and 100 g of ethyl acetate are added. The mixture is homogenized for 20 minutes and 68 g of 2-hydroxyethyl acrylate are then added. 0.4 g of Borchi KAT® 315 is added and the mixture is then maintained at 80-85° C. for 3 hours until no more NCO functions are visible on IR (disappearance of the characteristic band of the NCO function at about 2250 cm⁻¹).

When the mass percentage of NCO functions is less than 0.1% (no more NCO band visible), 200 g of ethyl acetate are added. The viscosity of composition A-2 thus obtained is measured on D+1, i.e. 24 hours after the end of the reaction (disappearance of the NCO band visible on IR), using a Brookfield viscometer (needle No. 3, 20 rpm). The viscosity of composition A-2 at 23° C. is about 5400 mPa·s.

The content of functions T of the polyurethane bearing end groups T is about 0.59 meq./g for a solids content of 70.0%.

### Example 3

### Preparation of the Compositions B

The compositions B that were tested were prepared by simple mixing of the polyamine(s) B1 and/or of the polyamine(s) B2 at room temperature (about 23° C.) in a B1/B2 weight ratio indicated below in table 1.

### Example 4

### Preparation of the Adhesive Compositions

The mixture of compositions A and B detailed in examples 1 to 3 was prepared in an A/B weight ratio indicated below in table 1.

Compositions 1 to 4 were prepared either from composition A of example 1 (A-1) or from composition A of example 2 (A-2).

Composition 2 (comparative) was prepared from a composition B comprising only one polyamine B1 (composition 2).

Compositions 1, 3 and 4 according to the invention were prepared, respectively, from the same composition B comprising a polyamine B1 and a polyamine B2.

TABLE 1
characteristics of the adhesive compositions tested

| | | | | B1 | B1 + B2 | | |
|---|---|---|---|---|---|---|---|
| | | | | NH₂ | NH₂ + NH | | r5 |
| | | | B1/B2 | alkalinity | alkalinity | A/B | mole |
| | Nature of A | Composition of B | ratio | (meq./g) | (meq./g) | ratio | ratio |
| Composition 1 | A-1 | Jeffamine ® | 8/2 | | 14.60 | 100/3.6 | 0.57 |
| | (Example 1) | EDR-148 | | | | | |
| | | (B1)/Lupasol ® | | | | | |
| | | FG (B2) | | | | | |
| Composition 2 | A-1 | Jeffamine ® | — | 13.50 | | 100/3.4 | 0.50 |
| (comparative) | (Example 1) | EDR-148 (B1) | | | | | |
| Composition 3 | A-1 | Jeffamine ® | 7/3 | | 15.15 | 100/3.7 | 0.61 |
| | (Example 1) | EDR-148 | | | | | |
| | | (B1)/Lupasol ® | | | | | |
| | | FG (B2) | | | | | |
| Composition 4 | A-2 | Jeffamine ® | 1/1 | | 16.25 | 100/4.0 | 1.10 |
| | (Example 2) | EDR-148 | | | | | |
| | | (B1)/Lupasol ® | | | | | |
| | | FG (B2) | | | | | |

The r5 mole ratio represents the mole ratio of the number of primary amine functions —NH₂ and secondary amine functions —NH— to the number of functions T as defined previously present in the adhesive composition (A+B).

### Example 5

### Preparation of the Complexes

Preparation of the supports: the layers of material are cut into the desired format and stapled to a Bristol board.
Preparation of the adhesive composition: composition A and composition B are mixed in a glass bottle, with optional addition of ethyl acetate. In the latter case, the solids content of the adhesive composition is about 30% by weight to have a basis weight of the order of 2 to 5 g/m² for each of the interfaces between two substrates.
Production of the multilayer (complex) structure:
   The adhesive is applied to an aluminum layer reinforced with polyethylene terephthalate (PET) using an applicator with a Mayer bar,
   Clips are attached to hold the support to the Bristol board on the non-stapled side and the support is placed in a ventilated oven for 2 minutes at 105° C. to evaporate the solvent,
   The glued support and the support to be laminated are stapled together on one edge. The clips are removed and the assembly is laminated using a pressure roller,
   The complex is placed in a press and left to crosslink either at room temperature (23° C.) or in a ventilated oven at 40° C. under a press (metal plates).

Various complexes were prepared using a BOPA/PE50 two-layer system defined below, each layer being separated by an adhesive layer as detailed in table 2 below:

TABLE 2
characteristics of the complexes

| | | Basis weight |
|---|---|---|
| | Adhesive composition | (g/m²) |
| Film 1 | Composition 1 | 4.2 |
| Film 2 | Composition 2 | 4.8 |
| | (comparative) | |
| Film 3 | Composition 3 | 4.5 |
| Film 4 | Composition 4 | 3.0 |

BOPA15/PE50: system consisting of a biaxially-oriented polyamide layer 15 μm thick (BOPA15) and of a polyethylene layer 50 μm thick (PE50).

PETALU/CPP: system consisting of a polyester layer laminated onto an aluminum layer and of a layer of polypropylene molded and slightly oriented in the machine direction (the CPP may be sealed and more resistant than the BOPP).

### Example 6

### Measurement of the Cohesion of the Complexes of Example 5 Before and After Pasteurization Test and Qualitative Assessment of the Resistance of Said Complexes to Pasteurization

### 180° Peel (Measurement of the Cohesion):

The cohesion of the complex is evaluated by the 180° peel test as described in the French standard NF T 54-122 (October 1976). The principle of this test consists in determining the force necessary to separate (or peel) two individual layers of the complex bonded by the adhesive.

A test specimen of rectangular shape 15 mm wide and about 15 cm long is cut out from the two-layer complex. The test specimens are cut out in the machine direction of the coating. The two individual layers of the complex included in this strip are manually detached from the end of this test specimen, and over approximately 2 cm, and the two free ends thus obtained are attached to two holding devices respectively connected to a stationary part and a movable part of a tensile testing device which are located on a vertical axis. While a drive mechanism imparts a uniform speed of 100 mm/minute to the movable part, resulting in the detachment of the two layers, the detached ends of which gradually move along a vertical axis with the formation of an angle of 180°, the stationary part-connected to a Zwick dynamometer-measures the force withstood by the test specimen thus held, which force is measured in newtons (N).

Each test is repeated three times and the mean value of the three measurements is indicated in table 3 below.

The measurement of the cohesion before pasteurization was performed seven days after manufacturing the multilayer film (D+7).

As illustrated in table 3 below, the cohesion was also measured 24 hours after pasteurization.

### Qualitative Assessment of the Resistance to Pasteurization and to Sterilization:

The quality of the adhesion between the layers of material of the multilayer structures tested, after pasteurization or sterilization, was also evaluated.

In particular, the presence or absence of unevennesses, which may be of various forms (for example channels or blisters) or bubbles was noted. The presence of these deformations of the multilayer structure reflects the infiltration of water between the layers of the multilayer structure resulting from degradation of the adhesive during the pasteurization or sterilization.

In addition, the adhesive was checked to see if it had un-crosslinked during the pasteurization. To do this, after having performed the peel test described above on each of the films tested, the presence or absence of tack (bonding power) was evaluated by exerting a gentle pressure of the index finger on the surface of the layer of adhesive left visible after separation of the layers of material.

The observations are collated in tables 3 and 4 below.

### Pasteurization Test/Sterilization Test

In the present example, the pasteurization test was performed once the adhesive had crosslinked in the complex (about 7 days after preparation of the complex in accordance with example 5). Sachets were prepared using a complex prepared in example 5, without sealing the fourth edge. The sachets are placed on an autoclave grate (vapor phase) and left for 30 minutes at 90° C.

In the present example, the sterilization test was performed once the adhesive had crosslinked in the complex (about 7 days after preparation of the complex in accordance with example 5). Sachets were prepared using a complex prepared in example 5, without sealing the fourth edge. The sachets are placed on an autoclave grate (vapor phase) and left for 1 hour at 130° C.

In table 3 below:
when “no tack” is observed, then the film passes the sterilization test (or, respectively, the pasteurization test),
when “tack” is observed, then the film does not pass the pasteurization test (or, respectively, the pasteurization test),
when channels are observed, then the film does not pass the sterilization test (or, respectively, the pasteurization test),
when a tear is observed, then the film passes the sterilization test (or, respectively, the pasteurization test).

TABLE 3
Measurement of the cohesion on PET/ALU/CPP (the measurement is performed on ALU/CPP)

| | | | Film 2 | | |
|---|---|---|---|---|---|
| | | Film 1 | (comparative) | Film 3 | Film 4 |
| Before sterilization | Time t at 40° C. | (D +7) | (D +7) | (D +7) | (D +7) |
| | Cohesion at time t | 3.5 | 1.9 | 3.5 | 3.2 |
| | (N/15 mm) | | | | |
| | Observation at time t | Adhesive | Cohesive | Adhesive | Adhesive |
| | | rupture on | rupture | rupture on | rupture on |
| | | CPP side | | ALU side | ALU side |
| 24 hours after | Cohesion (N/15 mm) | 3.7 | 0.1 | 3.7 | 3.5 |
| sterilization* | Observation | No tack - | Tack - | No tack - | No tack - |
| | | No channels | Delaminated | No channels | No channels |

*Sterilization 1 h at 130° C.

TABLE 4
Measurement of the cohesion on BOPA15/PE50

| | | Film 4 |
|---|---|---|
| Before | Time t at 40° C. | D +7 |
| pasteurization** | Cohesion at time t | 3.8 |
| | (N/15 mm) | |
| | Observation at time t | Adhesive |
| | | rupture PE |
| 30 mins after | Cohesion (N/15 mm) | 1.6 |
| pasteurization** | Observation | Appearance OK |
| | | adhesive rupture |
| | | (BOPA) |

**pasteurization 30 mins at 90° C.

1-19. (canceled)

20. A composition comprising:
a composition A comprising at least one polyurethane comprising at least two acrylic end functions T of formula (I) below:
CH₂═CH—C(═O)—X— (I)
with X representing —O— or —NRₐ— with Rₐ representing H or an alkyl radical comprising from 1 to 22 carbon atoms; and
a composition B comprising:
at least one polyamine B1 comprising only two groups —CH₂NH₂; and
at least one polyamine B2 comprising at least two primary amine functions —NH₂.

21. The composition as claimed in claim 20, wherein the polyurethane comprising at least two end functions T is obtained by reaction:
of a polyurethane comprising at least two —NCO end functions and of at least one compound chosen from a hydroxylated ester of acrylic acid or a hydroxylated amide of acrylic acid; or
of a polyurethane comprising at least two —OH end functions and of at least one compound chosen from an acrylic acid chloride or an acrylic acid ester.

22. The composition as claimed in claim 20, wherein the polyurethane comprising at least two end functions T is prepared via a process comprising the following steps:
E1) the preparation of a polyurethane bearing NCO end groups via a polyaddition reaction:
i. of at least one polyisocyanate;
ii. with at least one polyol; in amounts such that the NCO/OH mole ratio (r3) is strictly greater than 1; and
E2) the reaction of the product formed on conclusion of step E1) with at least one hydroxylated ester of acrylic acid or at least one hydroxylated amide of acrylic acid, in amounts such that the OH/NCO mole ratio (r4) is less than or equal to 1.

23. The composition as claimed in claim 20, wherein the hydroxylated ester of acrylic acid has the formula (II) below:
CH₂═CH—C(═O)—O—R⁰—OH (II)
wherein R⁰ represents a linear or branched, aliphatic or cyclic, saturated or unsaturated divalent hydrocarbon-based radical, being optionally interrupted with one or more heteroatoms, and/or optionally interrupted with one or more aromatic groups, and/or optionally interrupted with one or more divalent groups —N(R_{b})— with R_{b} representing a linear or branched alkyl radical comprising from 1 to 22 carbon atoms (tertiary amine), —C(═O)O— (ester), —C(═O)NH— (amide), —NHC(═O)O— (carbamate), —NHC(═O)—NH— (urea), or —C(═O)— (carbonyl), and/or being optionally substituted.

24. The composition as claimed in claim 20, wherein the hydroxylated ester of acrylic acid has one of the following formulae:
Formula (II-1):
CH₂═CH—C(═O)—O—R¹—OH (II-1)
wherein R¹ represents a linear or branched, aliphatic or cyclic, saturated or unsaturated divalent alkylene radical, comprising from 2 to 22 carbon atoms;
Formula (II-2):
CH₂═CH—C(═O)—O—R²—O—[C(═O)—(CH₂)ᵣ—O]ₛ—H (II-2)
wherein:
r is an integer ranging from 1 to 10;
s is an integer ranging from 1 to 10;
R² represents a linear or branched, aliphatic or cyclic, saturated or unsaturated divalent alkylene radical, comprising from 2 to 22 carbon atoms; or
Formula (II-3):
CH₂═CH—C(═O)—O—[R³—O]ₜ—H (II-3)
wherein R³ represents a linear or branched, aliphatic or cyclic, saturated or unsaturated divalent alkylene radical, comprising from 2 to 4 carbon atoms, and t is an integer ranging from 2 to 120.

25. The composition as claimed in claim 20, wherein the hydroxylated amide of acrylic acid has the formula (II′) below:
CH₂═CH—C(═O)—N(Rₐ)—e—OH (II′)
wherein Rₐ is as defined above, and R′⁰ represents a linear or branched, aliphatic or cyclic, saturated or unsaturated divalent hydrocarbon-based radical, being optionally interrupted with one or more heteroatoms (for instance N, O, S, and in particular O), and/or optionally interrupted with one or more aromatic groups, and/or optionally interrupted with one or more divalent groups —N(R_{b})— with R_{b} being as defined above (tertiary amine), —COO— (ester), —C(═O)NH— (amide), —NHC(═O)O— (carbamate), —NHC(═O)—NH— (urea), or —C(═O)— (carbonyl), and/or being optionally substituted.

26. The composition as claimed in claim 22, wherein the polyol(s) that are used are selected from the group consisting of polyester polyols, polyether polyols, polydiene polyols, polycarbonate polyols, poly(ether-carbonate) polyols, polymers having —OH end groups, and mixtures thereof.

27. The composition as claimed in claim 23, wherein the polyol(s) have a (mean) hydroxyl number (OHN) ranging from 5 to 840 milligrams of KOH per gram of polyol (mg KOH/g).

28. The composition as claimed in claim 23, wherein the polyisocyanate(s) are chosen from diisocyanates and triisocyanates,
the diisocyanates being selected from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo [2.2.1]heptane (2,5-NBDI), (2,6)-bis(isocyanatomethyl)bicyclo [2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI), toluene diisocyanate, diphenylmethane diisocyanate, tetramethylxylylene diisocyanate (TMXDI), an HDI allophanate having the formula (Y) below: 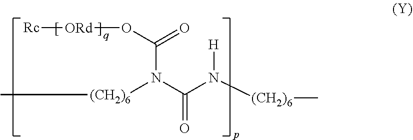
in which p is an integer ranging from 1 to 2, q is an integer ranging from 0 to 9, R_{c} represents a saturated or unsaturated, cyclic or acyclic, linear or branched hydrocarbon-based chain comprising from 1 to 20 carbon atoms, R_{d} represents a linear or branched divalent alkylene group containing from 2 to 4 carbon atoms, and a divalent propylene group; and mixtures thereof; and
the triisocyanates being selected from the group consisting of isocyanurates, biurets and adducts of diisocyanates and of triols.

29. The composition as claimed in claim 23, wherein:
the polyisocyanate(s) are chosen from toluene diisocyanate, meta-xylylene, HDI isocyanurate, and mixtures thereof; and/or
step E1) is performed in the presence of a mixture of polyols.

30. The composition as claimed in claim 20, wherein the polyamine B1 has the formula (III) below:
NH₂—CH₂—Z—CH₂₋NH₂ (III)
wherein Z represents a linear or branched, cyclic, aliphatic or aromatic, saturated or unsaturated divalent hydrocarbon-based radical, said hydrocarbon-based radical being optionally interrupted with one or more heteroatoms chosen from —S—, —O— and/or one or more divalent tertiary amine groups —NR″′— with R″′ representing a linear or branched, saturated or unsaturated alkyl group, comprising 1 to 22 carbon atoms;
polyamine B1 having one of the formulae (III-1), (III-2) or (III-3) below: 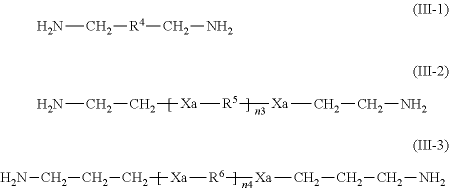
wherein:
R⁴ is a linear or branched divalent alkylene radical, or a divalent arylene radical, comprising from 1 to 18 carbon atoms, R⁴ representing a linear alkylene radical comprising 6, 10 or 12 carbon atoms;
R⁵ represents a linear or branched divalent alkylene radical comprising from 2 to 12 carbon atoms,
R⁶ represents a linear or branched divalent alkylene radical comprising from 2 to 10 carbon atoms,
Xₐ═O, S, NR⁷ wherein R⁷ represents H or a linear or branched, saturated or unsaturated alkyl group comprising from 1 to 10 carbon atoms;
n₃ is an integer ranging from 0 to 4;
n₄ is an integer ranging from 0 to 2.

31. The composition as claimed in claim 20, wherein polyamine B1 has a primary alkalinity of greater than or equal to 7 meq./g.

32. The composition as claimed in claim 20, wherein polyamine B2 or the mixture of polyamines B2 has a primary alkalinity strictly less than 10.00 meq./g.

33. The composition as claimed in claim 20, wherein polyamine B2 is chosen from the group consisting of polyetheramines, polyamidoamines, fatty amine dimers or trimers, polyethyleneimines (PEI), polyethyleneimine dendrimers, polypropyleneimines (PPI), polypropyleneimine dendrimers, polyallylamines, poly(propylene-ethylene)imines, and mixtures thereof.

34. The composition as claimed in claim 20, wherein polyamine B2 is chosen from
polyetherdiamines corresponding to the formula below: 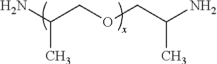
wherein x is an integer such that the primary alkalinity of the polyetherdiamine is between 0.5 and less than 10 meq./g;
polyetherdiamines corresponding to the formula below: 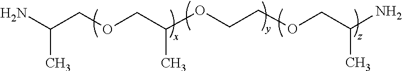
wherein x, y and z are integers such that the primary alkalinity is between 1 and less than 10 meq./g, x+z ranging from 1 to 6;
polyetherdiamines corresponding to the following formula:
H₂N—X_{b}(—O—X_{b})ₘ₋₁—O—(CH₂—CH₂—CH₂—CH₂—O)ₙ—(X_{b}—O)ₘ₋₁—X_{b}—NH₂
wherein X_{b} is a linear or branched alkylene group comprising from 2 to 20 carbon atoms, m is an integer ranging from 1 to 20 and n is an integer ranging from 1 to 100;
polyethertriamines corresponding to the formula below: 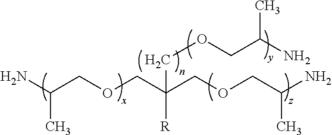
wherein R is a hydrogen atom or a C1 to C2 alkyl group, x, y, z and n are integers such that the primary alkalinity of the polyethertriamine is between 0.5 and less than 10 meq./g, and x+y+z ranging from 5 to 85.

35. The composition as claimed in claim 20, wherein polyamine B2 is chosen from polyethyleneimines (PEI) with a number-average molecular mass (Mn) ranging from 450 to 25,000 g/mol and a primary alkalinity/total alkalinity ratio ranging from 0.35 to 0.45, and in particular containing at least one radical having the following formula:

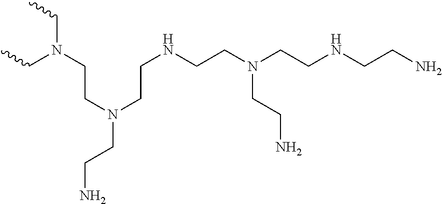

36. The composition as claimed in claim 20, wherein:
the polyamine(s) B1/polyamine(s) B2 mass ratio in composition B ranges from 90/10 to 10/90; and/or
the (NH₂+NH)/functions T mole ratio (denoted r5) in the composition ranges from 0.2 to 1.5.

37. A multilayer structure comprising at least two layers of material bonded together by an adhesive layer, wherein said adhesive layer comprises the composition as claimed in claim 20, in the crosslinked state.

38. A process for manufacturing the multilayer structure as claimed in claim 37, comprising the following steps:
mixing composition A and composition B, then
coating said mixture over a surface of a first layer of material, then
laminating the surface of a second layer of material over said coated surface, then
crosslinking said mixture.
